(19) United States
(12) Patent Application Publication
(10) Pub. No.: US 2001/0042685 A1
(43) Pub. Date: Nov. 22, 2001

(54) Gas sensor with an oxygen ion-conducting solid electrolyte

(75) Inventors: Silvia Lenaerts, Berchem (BE); Guido Cappa, Houthalen (BE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Heraeus Electro-Nite International N.V.

(21) Appl. No.: 09/841,726

(22) Filed: Apr. 25, 2001

(30) Foreign Application Priority Data
Apr. 27, 2000 (DE) 100 20 545.3

(51) Int. Cl. G01N 27/26

(52) U.S. Cl. 204/431; 204/424

(57) ABSTRACT

A gas sensor and a process are provided for manufacturing a gas sensor with an oxygen ion-conducting solid electrolyte, which has a measurement gas side and a reference gas side and which separates a measurement gas space from a reference gas space, at least one measurement electrode being arranged on the measurement gas side of the solid electrolyte and at least one reference electrode being arranged on the reference gas side of the solid electrolyte, and with a support which is gas-permeable at least in the area of the electrodes. The problem presents itself of providing an economical gas sensor, in which the gas supply to the electrodes takes place through a gas-permeable support, as well as providing a simple process for manufacturing the gas sensor. The problem is solved for the gas sensor in that the oxygen ion-conducting solid electrolyte and the electrodes are constructed as thin layers and are arranged on the gas-permeable support.

### BACKGROUND OF THE INVENTION

The invention relates to a gas sensor and a process for manufacturing a gas sensor with an oxygen ion-conducting solid electrolyte, which has a measurement gas side and a reference gas side, and which separates a measurement gas space from a reference gas space, with at least one measurement electrode arranged on the measurement gas side of the solid electrolyte, and with at least one reference electrode arranged on the reference gas side of the solid electrolyte, as well as with a support which is gas-permeable at least in the region of the electrodes.

A representative gas sensor of this type is known from U.S. Pat. No. 5,186,809. Here, a ceramic tube closed on one end is disclosed, which is provided with bore holes in the region of the electrodes. An oxygen ion-conducting solid electrolyte constructed as a green sheet is printed with measuring and reference electrodes, and the printed green sheet is pressed on the outer diameter of the already sintered ceramic tube. Here, the reference electrodes are arranged over the bore holes in the ceramic tube. Subsequently, the printed green sheet and the ceramic tube are sintered without pressure, wherein the green sheet is sintered onto the ceramic tube and a firm bond is created. The bore holes in the ceramic tube make possible the supply of a reference gas to the reference electrodes. The sensor is very expensive in its manufacture, since in addition to the manufacturing and printing of the green sheet, the composite of green sheet and electrodes must be pressed on the already sintered ceramic tube, and a second sintering step is necessary. The expenditure in apparatus, energy and manufacturing costs are consequently high.

German published patent application DE 37 09 196 A1 describes an oxygen measuring probe for high temperatures with a porous air supply tube in a gas-tight solid electrolyte tube, wherein a first metallic conductor is wrapped on the air supply tube in the region of the electrodes. Between the porous air supply tube and the solid electrolyte tube, in the region of the first metallic conductor, a powder-form oxide electron conductor is poured in and fixed. Radially thereto a second metallic conductor is wrapped on the solid electrolyte tube. This arrangement is inserted centrally into a probe head. In the region of the second metallic conductor, a further powder-form oxide electron conductor is now poured in and fixed. The fixation of the powder filling takes place by refractory hardening compounds, preferably cements. Even this probe arrangement is costly in its manufacture and expensive, since numerous individual steps are necessary for completion.

### BRIEF SUMMARY OF THE INVENTION

The problem arises of providing an economical gas sensor, with which the gas supply for the electrodes takes place through a gas-permeable support, as well as providing a simple process for manufacturing the gas sensor.

The problem is solved for the gas sensor in that the oxygen ion-conducting solid electrolyte and the electrodes are constructed as thin layers and are arranged on the gas-permeable support.

By a thin layer is here to be understood a planar structure which cannot arise without a support, wherein the layer formation first takes place on the support. The gas-permeable support must accordingly have at least in part a coatable surface on which the thin layers can be applied. A support is here designated as gas-permeable if the gas can reach the electrode or flow without a diffusion process.

Contrary to expectations, it is rapidly and economically possible to arrange the electrodes and the gas-tight solid electrolyte as thin layers on the surface of the gas-permeable support having openings for the gas passage. The gas-permeable support thereby fulfills first the function of enabling the access of the measurement or reference gas to the measurement or reference electrodes, and at the same time guaranteeing, by its configuration as support, the accommodation of the layer materials and the formation of the thin layers.

For use of the gas sensor at high temperatures, as prevail, for example, in the exhaust conduit of a motor vehicle, gas-permeable supports made of ceramic, glass, metal or composites of these are used. For applications at low temperatures, other materials can be used instead, for example plastics.

The thin layers can be particularly easily applied on the gas-permeable support, if this has an open porosity. An open-pored support material, which has pores with diameters in a range of 0.1 μm to 10 μm, has proven itself particularly well, since a sufficient gas permeability is surely guaranteed, and at the same time the time expended for application of the thin layers remains short.

But even a gas-permeable support is usable, which is constructed of a gas-tight material, wherein this gas-tight material is provided at least in the region of the electrodes with gas passage openings. The gas passage openings in the gas-tight material can preferably be executed as bore holes or with the help of a laser.

Advantageous in the gas-tight material are gas passage openings with a diameter in a range of 10 μm to 1000 μm. In this range the manufacture of the gas passage openings is relatively simple and the time requirement for the application of gas-tight thin layers is still relatively short.

In the area of the exhaust gas sensor technology, it is advantageous if the gas-permeable support is made of an electrically non-conducting aluminum oxide. The gas-permeable support can, however, also be electrically conducting and at the same time be constructed as a measurement or reference electrode of the gas sensor. Thus at least the process of applying at least one electrode is spared.

It is especially economical if the thin layers on the gas-permeable support are manufactured in a thin and/or thick layer technology. By this are generally to be understood physical or chemical vapor deposition processes, as well as various types of a mechanical layer application. Thus, the thin layers can be produced at least in part by screen printing and/or vapor deposition and/or sputtering and/or plasma spraying. But other possibilities are also usable, for example, short dipping of the gas-permeable material into a solution or suspension. In all suitable processes it is decisive that the layers are first formed on the support and do not already exist as a layer without the support, as in the foil technology.

In order to form the thin layer of the oxygen ion-conducting solid electrolyte gas-tight, a mean layer thickness in a range of 10 μm to 100 μm has proven satisfactory. As oxygen-ion conducting solid electrolytes, among others, doped ZrO₂ or CeO₂ are advantageous.

It should be stressed that, additionally on the gas sensor of the invention, heating elements, insulating layers, temperature sensor elements or the like can be arranged, which, however, will not be particularly discussed here.

The problem is solved for the process in that the oxygen ion-conducting solid electrolyte and the electrodes are applied as thin layers on the gas-permeable support. With the process of the invention, large savings in time and costs result in comparison with the usual production methods, owing to the fewer operations necessary and the simply automatable sequences. An application of the thin layers using a thin and/or thick layer technique is particularly economical here. As already indicated above for the gas sensor, physical or chemical vapor deposition processes, as well as various types of mechanical layer applications, are generally to be understood by this. Advantageous are automatable processes such screen printing and/or vapor deposition and/or sputtering and/or plasma spraying. Of course, when applying a screen printing layer, it is necessary to add a firing process of the thin layers on the gas-permeable support in order to fix the screen print layers, while this subsequent temperature process can be omitted, for example, with plasma spraying.

The gas-permeable support can be made of ceramic and/or glass and/or metal. A gas-permeable support can be executed with an open porosity, in particular with pores having a diameter in a range of 0.1 μm to 10 μm. But even a gas-permeable support which is formed of a gas-tight material, wherein the gas-tight material is provided with gas passage openings at least in the area of the electrodes, has proven itself. Here the gas passage openings, which are preferably executed with a diameter in a range of 10 μm to 100 μm, can be produced by drilling or with the aid of a laser.

The use of aluminum oxide for the gas-permeable support is just as advantageous as a support, which is constructed electrically conducting and constructed as an electrode of the gas sensor.

Gas-tight, thin layers of oxygen ion-conducting solid electrolyte, for example doped ZrO₂ or CeO₂, are preferably produced with a mean layer thickness in a range of 10 μm to 100 μm.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a plan view of an unrolled casing surface of a tube-shaped gas sensor according to a first embodiment of the invention with an electrically non-conducting, gas-permeable support, which is formed by means of a gas passage opening through tight material;

FIG. 2 is a cross section through the gas sensor according to FIG. 1 taken along line A-A″;

FIG. 3 is a plan view of an unrolled casing surface of a tube-shaped gas sensor according to a second embodiment of the invention with an electrically conducting, gas-permeable support, which has an open porosity;

FIG. 4 is a cross section through the gas sensor according to FIG. 3 taken along line B-B″;

FIG. 5 is a plan view of an unrolled casing surface of a tube-shaped gas sensor according to a third embodiment of the invention with an electrically non-conducting, gas-permeable support, which has an open porosity;

FIG. 6 is a cross section through the gas sensor according to FIG. 5 taken along line C-C″;

FIG. 7 is a plan view of an unrolled casing surface of a tube-shaped gas sensor according to a fourth embodiment of the invention with an electrically-conducting, gas-permeable support, which is formed by means of a gas passage opening through gas-tight material;

FIG. 8 is a cross section through the gas sensor according to FIG. 7 taken along line D-D″;

FIG. 9 is a schematic plan view of a planar gas sensor according to a fifth embodiment of the invention with an electrically non-conducting, gas-permeable support, which has an open porosity; and

FIG. 10 is a cross section through the gas sensor according to FIG. 9 taken along line E-E″.

### DETAILED DESCRIPTION OF THE INVENTION

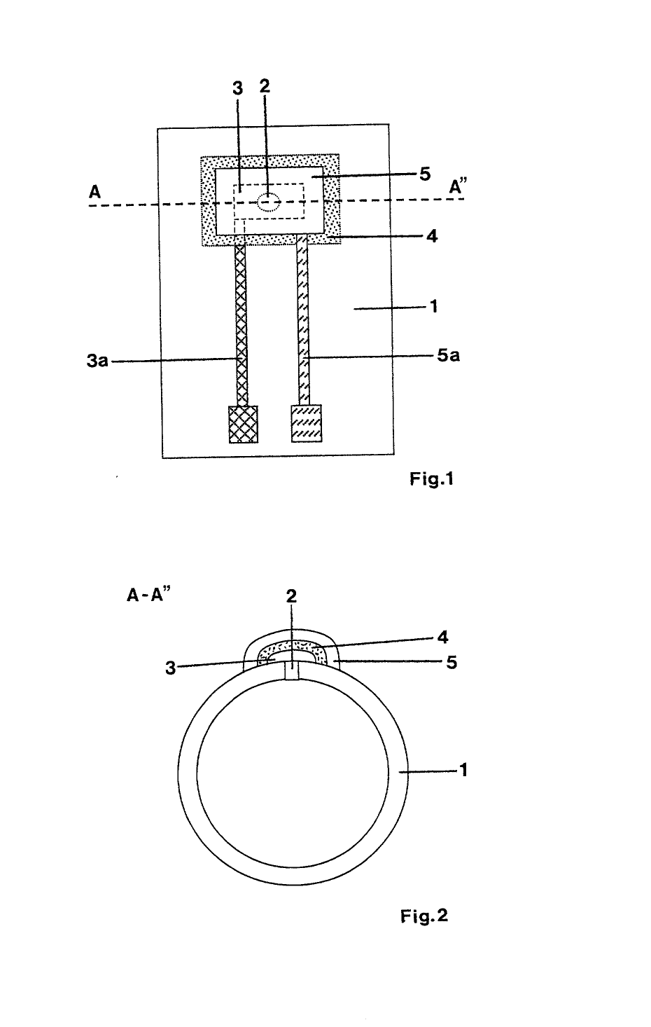

FIG. 1 shows the unrolled casing surface of a gas sensor, in which the gas-permeable support 1 has the form of a tube closed on one end. The gas-permeable support 1 is made of gas-tight, electrically non-conducting Al₂O₃, wherein in the region of the electrodes, a single gas passage opening 2 is arranged. The gas passage opening 2 is a bore hole and allows a reference gas supply to the porous reference electrode 3 (represented in dashed lines), which was screen printed as a thin layer on the gas-permeable support 1. The reference electrode 3 is completely covered by a screen printed, gas-tight, thin layer of oxygen ion-conducting solid electrolyte 4. On the solid electrolyte layer 4, there is situated a screen-printed, porous measurement electrode 5. The reference electrode 3 and the measurement electrode 5 are bonded with screen printed leads 3a; 5a.

FIG. 2 shows the tube-shaped, gas-permeable support 1 and the thin layers in cross section. The section A-A″ was taken through the electrodes, whereby the gas passage opening 2 is to be recognized in the area of the porous reference electrode 3. The reference electrode 3 is completely covered by the oxygen ion-conducting solid electrolyte 4, whereby the reference gas space in the tube is separated from the measurement gas space outside the tube. On the solid electrolyte layer 4, a screen printed, porous measurement electrode 5 is situated.

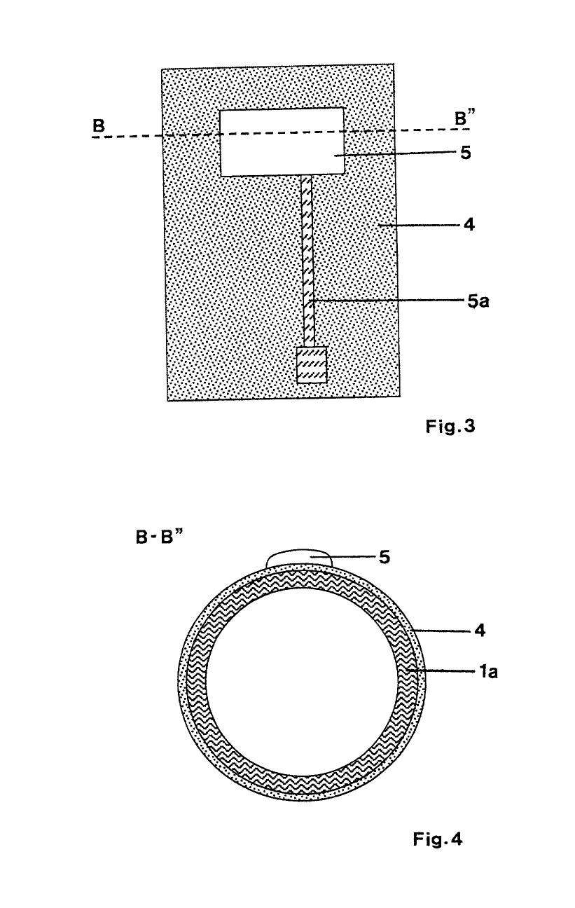

FIG. 3 shows the unrolled casing surface of a gas sensor, in which the gas-permeable support 1a (see FIG. 4) has the form of a tube closed on one end and is completely covered by a gas-tight, plasma-sprayed, solid electrolyte layer 4. The gas-permeable support 1a is made of an open-pored, electrically-conducting, metal-ceramic composite, which enables an all round gas entry. Owing to the electrical conductivity of the metal-ceramic composite, the gas-permeable support 1a can be used simultaneously as a reference electrode. On the plasma-sprayed, solid electrolyte layer 4, a porous, plasma-sprayed measurement electrode 5 is situated. The measurement electrode 5 is bonded with a lead 5a.

FIG. 4 illustrates the tube-shaped, gas-permeable support 1a and the thin layers in cross section. The section B-B″ was taken through the measurement electrode 5. The gas-permeable support 1a is completely covered by a gas-tight, thin layer of oxygen ion-conducting solid electrolyte 4, whereby the reference gas space in the tube is separated from the measurement gas space outside the tube. On the solid electrolyte layer 4, the porous measurement electrode 5 is situated.

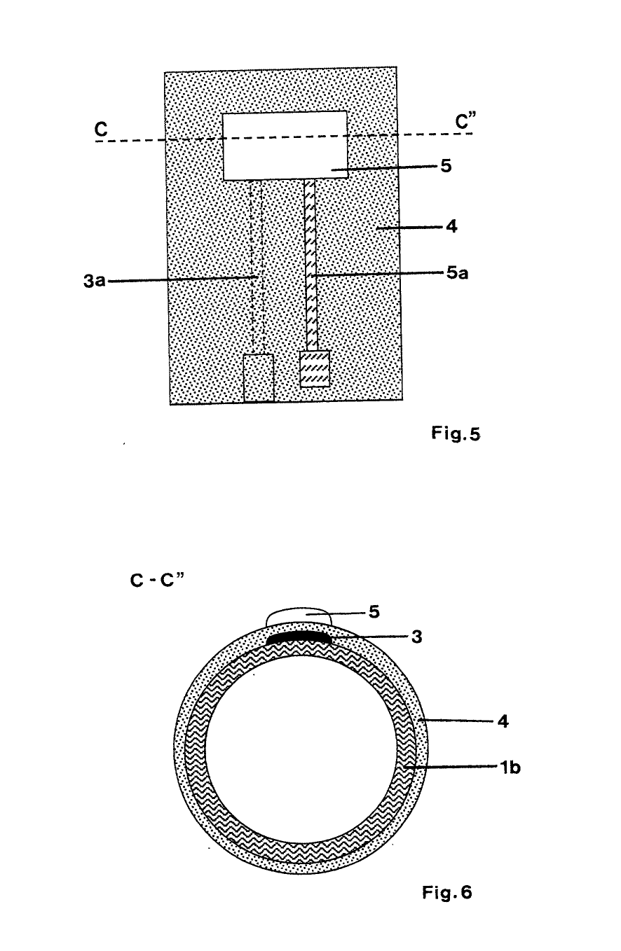

FIG. 5 depicts the unrolled casing surface of a gas sensor, in which the gas-permeable support 1b (see FIG. 6) has the form of a tube closed on one end. The gas-permeable support 1b is made of open-pored, electrically non-conducting Al₂O₃ and allows a reference gas supply to the, here not visible, porous reference electrode 3, which was sputtered as a thin layer on the gas-permeable support 1b. The reference electrode 3 and the gas-permeable support 1b are completely covered by a gas-tight, thin layer of oxygen ion-conducting solid electrolyte 4. On the solid electrolyte layer 4, a sputtered, porous measurement electrode 5 is situated. The reference electrode 3 and the measurement electrode 5 are bonded with leads 3a; 5a.

FIG. 6 illustrates the tube-shaped, gas-permeable support 1b and the thin layers in cross section. The section C-C″ was taken through the measurement electrode 5. The gas-permeable support 1b and the reference electrode 3 are completely covered by a gas-tight, thin layer of oxygen ion-conducting solid electrolyte 4, whereby the reference gas space in the tube is separated from the measurement gas space outside the tube. On the solid electrolyte layer 4, the porous measurement electrode 5 is situated.

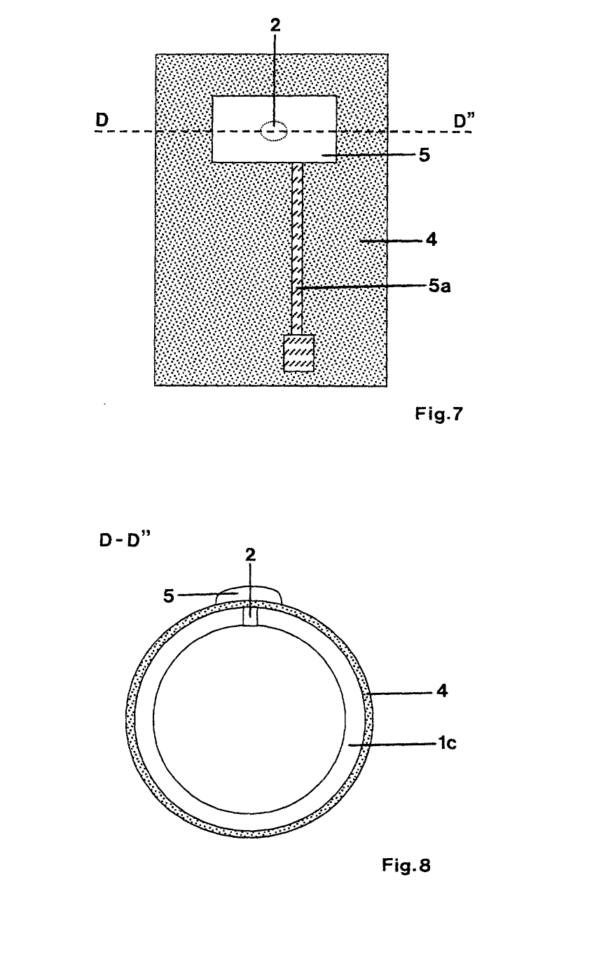

FIG. 7 shows the unrolled casing surface of a gas sensor, in which the gas-permeable support 1c (see FIG. 8) has the form of a tube closed on one end. The gas-permeable support 1c is made of gas-tight, electrically-conducting ceramic, wherein in the region of the electrodes, a single gas passage opening 2 is arranged. Owing to the electrical conductivity of the gas-permeable support 1c, it can be used simultaneously as a reference electrode. The support 1c is completely covered by a screen printed, gas-tight, thin layer of oxygen ion-conducting solid electrolyte 4. On the solid electrolyte layer 4, a screen printed, porous measurement electrode 5 is situated. The measurement electrode 5 is bonded with a lead 5a.

FIG. 8 shows the tube-shaped, gas-permeable support 1c and the thin layers in cross section. The section D-D″ was taken through the measurement electrode 5, whereby the gas passage opening 2 is to be recognized. The gas-permeable support 1c is completely covered by a gas-tight, thin layer of oxygen ion-conducting solid electrolyte 4, whereby the reference gas space in the tube is separated from the measurement gas space outside the tube. A screen printed, porous measurement electrode 5 is situated on the solid electrolyte layer 4.

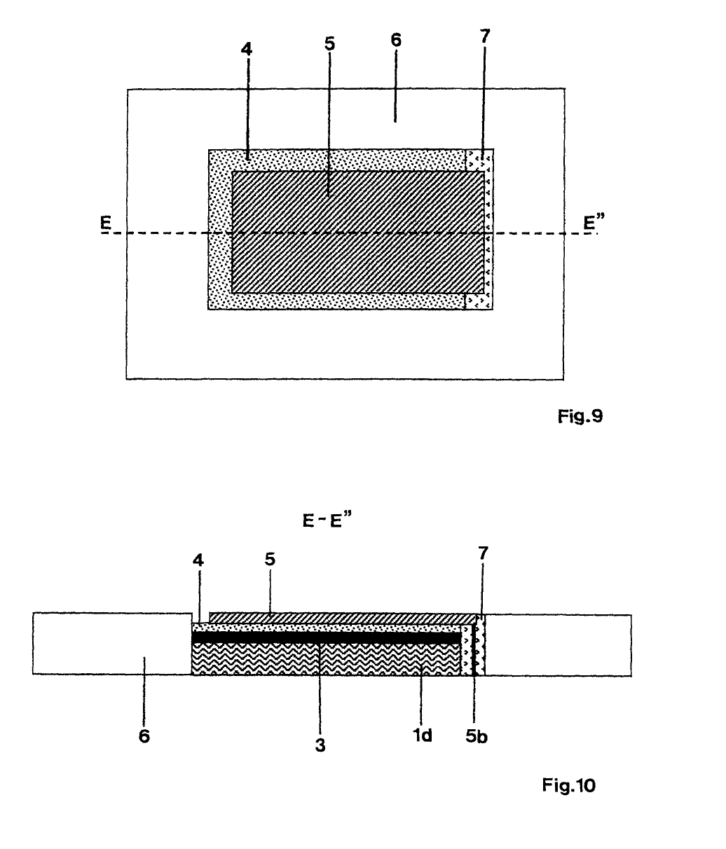

FIG. 9 illustrates schematically a planar gas sensor in plan view, which is installed in the metallic wall 6 of an exhaust conduit in a motor vehicle. A gas-permeable support 1d (see FIG. 10) of open-pored, electrically non-conducting Al₂O₃ is covered with a porous reference electrode 3. A gas-tight, solid electrolyte layer 4 covers the gas-permeable support 1d and the reference electrode 3. On the solid electrolyte layer 4, a measurement electrode 5 is situated, which is bonded by a lead 5b (see FIG. 10), wherein the lead 5b is arranged in an electrically non-conducting structure 7. The contacting of the reference electrode 3 can take place through the wall 6.

FIG. 10 shows the planar, gas-permeable support 1d and the thin layers in cross section. The section E-E″ was taken through the measurement electrode 5. The gas-permeable support 1d and the porous reference electrode 3 are completely covered by a gas-tight, thin layer of oxygen ion-conducting solid electrolyte 4, whereby the reference gas space outside the exhaust conduit is separated from the measurement gas space inside the exhaust conduit. On the solid electrolyte layer 4, a porous measurement electrode 5 is situated, which is contacted via lead 5b, wherein the lead 5b is arranged in an electrically non-conducting structure 7.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A gas sensor comprising an oxygen ion-conducting solid electrolyte, having a measurement gas side and a reference gas side, the solid electrolyte separating a measurement gas space from a reference gas space, at least one measurement electrode arranged on the measurement gas side of the solid electrolyte, at least one reference electrode arranged on the reference gas side of the solid electrolyte, and a support which is gas-permeable at least in a region of the electrodes, wherein the oxygen ion-conducting solid electrolyte and the electrodes are constructed as thin layers and are arranged on the gas-permeable support.

2. The gas sensor according to claim 1, wherein the gas-permeable support is made of a material selected from the group consisting of ceramic, glass and metal.

3. The gas sensor according to claim 1, wherein the gas-permeable support comprises an open pored material.

4. The gas sensor according to claim 3, wherein the open-pored support material has pores with a diameter in a range of 0.1 μm to 10 μm.

5. The gas sensor according to claim 1, wherein the gas-permeable support comprises a gas-tight material provided with gas passage openings at least in an area of the electrodes.

6. The gas sensor according to claim 5, wherein the gas passage openings comprise bore holes.

7. The gas sensor according to claim 5, wherein the gas passage openings are formed by a laser.

8. The gas sensor according to claim 5, wherein the gas passage openings have a diameter in a range of 10 μm to 1000 μm.

9. The gas sensor according to claim 1, wherein the gas-permeable support comprises aluminum oxide.

10. The gas sensor according to claim 1, wherein the gas-permeable support is electrically conducting and is constructed as a measurement or reference electrode of the gas sensor.

11. The gas sensor according to claim 1, wherein the thin layers are formed in a thin and/or thick layer technology.

12. The gas sensor according to claim 11, wherein the thin layers are made at least in part by a process selected from the group consisting of screen printing, vapor deposition, sputtering, and plasma spraying.

13. The gas sensor according to claim 1, wherein the thin layer of oxygen ion-conducting solid electrolyte has a mean layer thickness in a range of 10 μm to 100 μm.

14. The gas sensor according to claim 1, wherein the oxygen ion-conducting solid electrolyte comprises doped ZrO₂ or CeO₂.

15. A process for manufacturing a gas sensor with an oxygen ion-conducting solid electrolyte, having a measurement gas side and a reference gas side, where the solid electrolyte separates a measurement gas space from a reference gas space, at least one measurement electrode arranged on the measuring gas side of the solid electrolyte and at least one reference electrode arranged on the reference gas side of the solid electrolyte, and a support which is gas-permeable at least in an area of the electrodes, comprising the step of applying the oxygen ion-conducting solid electrolyte and the electrodes as thin layers on the gas-permeable support.

16. The process according to claim 15, wherein the thin layers are applied by a thin and/or thick layer technique on the gas-permeable support.

17. The process according to claim 16, wherein the thin layers are applied by a process selected from the group consisting of screen printing, vapor deposition, sputtering, and plasma spraying.

18. The process according to claim 15, wherein the gas-permeable support is made of a material selected from the group consisting of ceramic, glass and metal.

19. The process according to claim 15, wherein the gas-permeable support is constructed with an open porosity.

20. The process according to claim 19, wherein the open porosity is constructed with pores having a diameter in a range of 0.1 μm to 10 μm.

21. The process according to claim 15, wherein the gas-permeable support is made of a gas-tight material provided with gas passage openings at least in an area of the electrodes.

22. The process according to claim 21, wherein the gas passage openings are produced by drilling.

23. The process according to claim 21, wherein the gas passage openings are produced by a laser.

24. The process according to claim 21, wherein the gas passage openings are produced with a diameter in a range of 10 μm to 1000 μm.

25. The process according to claim 15, wherein the gas-permeable support is made of aluminum oxide.

26. The process according to claim 15, wherein the gas-permeable support is constructed electrically conducting and is used as a measurement or reference electrode of the gas sensor.

27. The process according to claim 15, wherein the thin layer is made of oxygen ion-conducting solid electrolyte having a mean layer thickness in a range of 10 μm to 100 μm.

28. The process according to claim 15, wherein the oxygen ion-conducting solid electrolyte is made of doped ZrO₂ or CeO₂.
